(19) United States
(12) Patent Application Publication
(10) Pub. No.: US 2020/0034441 A1
(43) Pub. Date: Jan. 30, 2020

(54) COGNITIVE EXPERIENCE ASSESSMENT WITH VISUAL INDICATOR

(71) Applicant: International Business Machines Corporation, Armonk, NY (US)

(72) Inventors: Trudy L. Hewitt, Cary, NC (US); Jonathan Dunne, Dungarvan (IE); Kelley Anders, East New Market, MD (US); Kimberly Dawn McCall, Leander, TX (US)

(21) Appl. No.: 16/047,616

(22) Filed: Jul. 27, 2018

(51) Int. Cl. G06F 17/30

(52) U.S. Cl. CPC G06F 17/3053; G06F 17/30867; G06F 17/30905; G06F 17/30722

(57) ABSTRACT

Methods and systems for formatting a display of user inputs are described. In an example, a processor may receive input data relating to a topic, where the input data may be associated with a user. The processor may establish a baseline skill level in the topic based on the user. The processor may extract a portion of the input data. The processor may determine a topic skill level associated with the extracted portion. The processor may compare the baseline skill level with the topic skill level. The processor may format a display of the user input based on a result of the comparison. The processor may output the formatted user input on a user interface, wherein the formatted user input indicates a user skill level of the user in the topic.

### FIELD

The present application relates generally to computers, and computer applications, and more particularly to computer-implemented methods and systems relating to web application management systems.

### BACKGROUND

Web applications, such as forums, websites, blogs, emails, social networks, may provide a platform for users to make statements and assertions on various topics. In some examples, a reliability of the statements and assertions may not be ascertainable as the authors of the statements and assertions may be unknown to users of the web applications.

### SUMMARY

In some examples, a method for formatting a display of a user input is generally described. The method may include receiving, by a processor, input data relating to a topic, where the input data may be associated with a user. The method may further include establishing, by the processor, a baseline skill level in the topic based on the user. The method may further include extracting, by the processor, a portion of the input data. The method may further include determining, by the processor, a topic skill level associated with the extracted portion. The method may further include comparing, by the processor, the baseline skill level with the topic skill level. The method may further include formatting, by the processor, a display of the user input based on a result of the comparison. The method may further include outputting, by the processor, the formatted user input on a user interface. The formatted user input may indicate a user skill level of the user in the topic.

In some examples, a system for formatting a display of a user input may be generally described. The system may include a memory and a processor configured to be in communication with each other. The processor may be configured to receive input data relating to a topic, where the input data may be associated with a user. The processor may be further configured to establish a baseline skill level in the topic based on the user. The processor may be further configured to extract a portion of the input data. The processor may be further configured to determine a topic skill level associated with the extracted portion. The processor may be further configured to compare the baseline skill level with the topic skill level. The processor may be further configured to format a display of the user input based on a result of the comparison. The processor may be further configured to output the formatted user input on a user interface. The formatted user input may indicate a user skill level of the user in the topic.

In some examples, a computer program product for formatting a display of a user input is generally described. The computer program product may include a computer readable storage medium having program instructions embodied therewith. The program instructions may be executable by a processing element of a device to cause the device to perform one or more methods described herein.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an example computer system that can be utilized to implement cognitive experience assessment with visual indicator in one embodiment.

FIG. 2 illustrates an example implementation of cognitive experience assessment with visual indicator in one embodiment.

FIG. 3 illustrates a flow diagram relating to cognitive experience assessment with visual indicator in one embodiment.

FIG. 4 illustrates a schematic of an example computer or processing system that may implement cognitive experience assessment with visual indicator in one embodiment.

FIG. 5 depicts a cloud computing environment according to an embodiment of the present invention.

FIG. 6 depicts abstraction model layers according to an embodiment of the present invention.

### DETAILED DESCRIPTION

In an example, a first user may generate content relating to a topic. For example, the first user may write a blog about how to log in to a computer system, including details on the underlying mechanisms and handshakes that are required in the login process. A second user viewing the content generated by the first user may wish to know an amount of knowledge and experience of the first user in the topic, in order to assess a reliability of the content. For example, the second user may wish to know whether the first user has sufficient experience with computers, in order to make an assessment of whether to try using the login method described by the content.

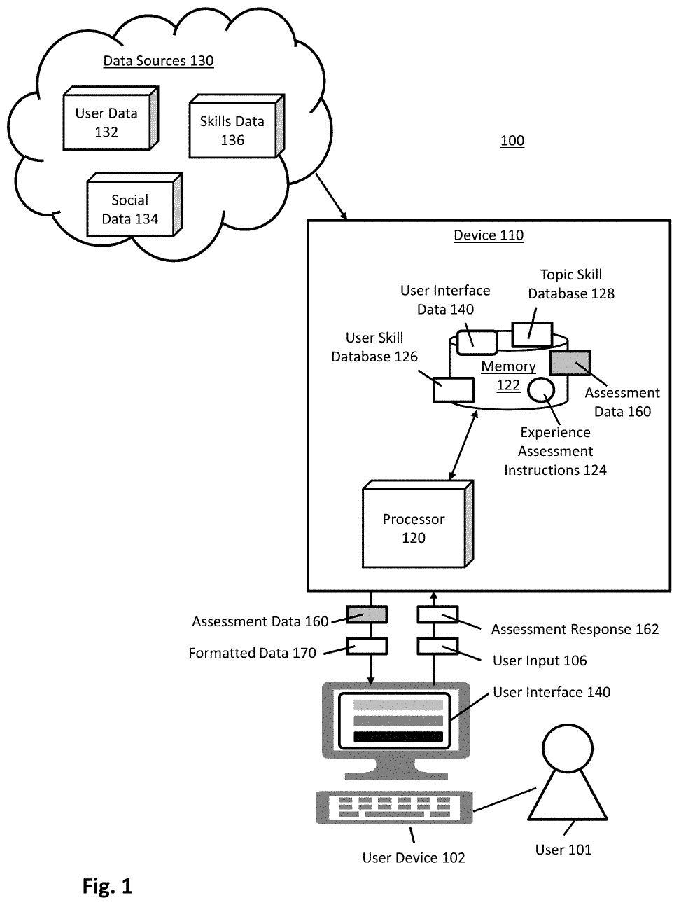

A system in accordance with the present disclosure (e.g., system 100 in FIG. 1) may provide methods for providing visual indicators in contents being viewed by users on a network, where the visual indicators allow the users on the network to be aware of experience levels of authors of the contents. If a user is not an expert, the system 100 may generate a questionnaire to test the skill level of the user, and based on responses from the user, format the text input by the user to represent a skill level of the user in the topic. The system 100 may be implemented by web application management systems, such that the web application management systems may be improved by providing the feature to display content formatted based on experience of authors in particular topics. By providing the formatted content, the web application management systems may enhance user experience of the users of a web application, such as providing visual indicators on content to assist users in determining a reliability of the content.

FIG. 1 illustrates an example computer system 100 that can be utilized to implement cognitive experience assessment with visual indicator, arranged in accordance with at least some embodiments described herein. In some examples, the system 100 may be implemented with a computer device 110. The device 110 may include a processor 120 and a memory 122 configured to be in communication with each other. The processor 120 may be a central processing unit of the device 110. In some examples, the processor 120 may be configured to control operations of the memory 122 and/or other components of the device 110. In some examples, the device 110 may include additional hardware components, such as programmable logic devices, microcontrollers, memory devices, and/or other hardware components, that may be configured to perform respective tasks of the methods described in the present disclosure. In some examples, the processor 120 may be configured to execute software modules that include instructions to perform each respective task of the methods described in the present disclosure. In some examples, the device 110, the processor 120, and/or the memory 122 may each be resources of a cloud computing platform.

The memory 122 may be configured to selectively store instructions executable by the processor 120. For example, in one embodiment, the memory 122 may store a set of experience assessment instructions 124 (herein “instructions 124”), where the instructions 124 may include instructions, such as executable code, related to natural language processing, image processing, dataset processing, and/or other algorithms or techniques, which may implement the system 100. The processor 120 may be configured to execute one or more portions of the instructions 124 in order to facilitate implementation of the system 100. In some examples, the instructions 124 may be packaged as a standalone application that may be installed on the computer device implementing the system 100, such that the instructions 124 may be executed by the processor 120 to implement the system 100. In some examples, the instructions 124 may be stored in a programmable hardware component that may be embedded as part of the processor 120.

The memory 122 may be further configured to store a user skill database 126. The user skill database 126 may include mappings of one or more users to one or more levels of one or more topics. For example, a user A may be an expert in computer science, but may be a novice in culinary arts, whereas a user B may have no experience in computer science but is an expert in culinary arts. The user skill database 126 may indicate user A is mapped to an expert level in computer science, and also mapped to a novice level in culinary arts. The user skill database 126 may also indicate user B is mapped to no experience in computer science, but also mapped to an expert level in culinary arts.

The memory 122 may be further configured to store a topic skill database 128 that may be generated by the system 100 and/or another system or device different from the system 100. The topic skill database 128 may include mappings of one or more texts and/or phrases to one or more levels of one or more topics. For example, a phrase “fry an egg” may be mapped to a novice level in culinary arts, and a phrase “finite automata” may be mapped to an expert level in computer science.

The user skill database 126 and the topic skill database 128 may include data from a plurality of data sources 130. Data sources 130 may include devices and platforms that may provide user data 132, social data 134, skills data 136, and/or other types of data relating to a plurality of users and skills in various fields or topics. The user data 132 may include data input directly from users, such as name, location, occupation, and/or other user data. The social data 134 may include data from one or more social network platform, such as data relating to user preferences, hobbies, friends, and/or other social data. The skills data 136 may be provided by educational resources, online training courses, training videos, and/or other resources where skills of various topics are documented, profiled, and classified into different levels. For example, skills data 136 may include a plurality of videos of lectures at various levels of a particular topic, where the plurality of videos may be obtained from online streaming services. The system 100 may use and/or access the user skill database 126 and the topic skill database 128 to perform the methods described in the present disclosure.

The memory 122 may be further configured to store assessment data 160, where assessment data 160 may be used to assess or evaluate a skill level of a user in one or more topics. For example, the assessment data 160 may include a document such as a questionnaire, or may include an executable file that prompt a user to select various items (e.g., picture, text, answers), and/or other types of files or documents that may be used by the system 100 to assess a skill level of a user. Each piece of assessment data 160 may be mapped to a particular topic and skill level of the mapped topic, where the mappings may be stored in the memory 122. For example, the assessment data 160 may include different questionnaires for different skill levels in the topic of computer science.

In an example, a user 101 may use a user device 102 to generate a user input 106, where the user input 106 may include texts, numbers, or other inputs that may be generated by the user device 102. For example, the user 101 may type a message using a keyboard of the user device 102, and the device 110 may receive the user input 106 by monitoring the keys entered by the user 101 on the keyboard. The processor 120 may establish a baseline skill level by identifying a current skill level of the user 101 indicated in the user skill database 126. The processor 120 of the device 110 may receive the user input 106 and may execute natural language processing techniques to extract portions, such as particular texts, from the user input 106. The processor 120 may search for the extracted portions (e.g., texts) in the topic skill database 128 to determine a skill level and topic that is mapped to the extracted portion. The processor 120 may compare the skill level of the extracted portion with the established baseline skill level.

If the comparison indicates a match, then the processor 120 may format the user input 106 in accordance with the matched skill level, which may be the baseline skill level of the user 101 due to the match. If the comparison indicates a mismatch, then the processor 120 may determine the user skill level of the user 101 by sending the assessment data 160 to the user device 102. In some examples, the processor 120 may generate the assessment data 160 in response to the mismatch. The user 101 may respond to the assessment data 160 by using the user device 102 to send an assessment response 162 to the device 110. The processor 120 may determine the user skill level of the user 101, which may be different (e.g., higher or lower, more or less experienced) from the baseline skill level, based on the assessment response 162. Upon determining the user skill level of the user 101, the processor 120 may format a display of the user input 106 based on the determined user skill level of the user 101. The processor 120 may send formatted data 170, which is the formatted version of the user input 106, to the user device 102 in order to display the formatted user input 106. Thus, the user input 106 that may be outputted on the user interface 140 may be formatted with various visual indicators to depict a skill level of an author of the information displayed on the user input 106.

By formatting the user input 106 based on skill level of the user 101, another user viewing the display of the user input 106 may determine a reliability of the displayed information based on the formatting of the displayed information. The formats that may be used as visual indicators may include different pixel values, visual forms, font type, font formatting (e.g., bold, italic, underline), font size, font case (e.g., uppercase or lowercase texts), shadings, shadows, boxes around texts, and/or other types of formatting. For example, texts authored by a novice user may be displayed as pixels of a first value, texts authored by an intermediate user may be displayed as pixels of a second value, and texts authored by an expert user may be displayed as pixels of a third value.

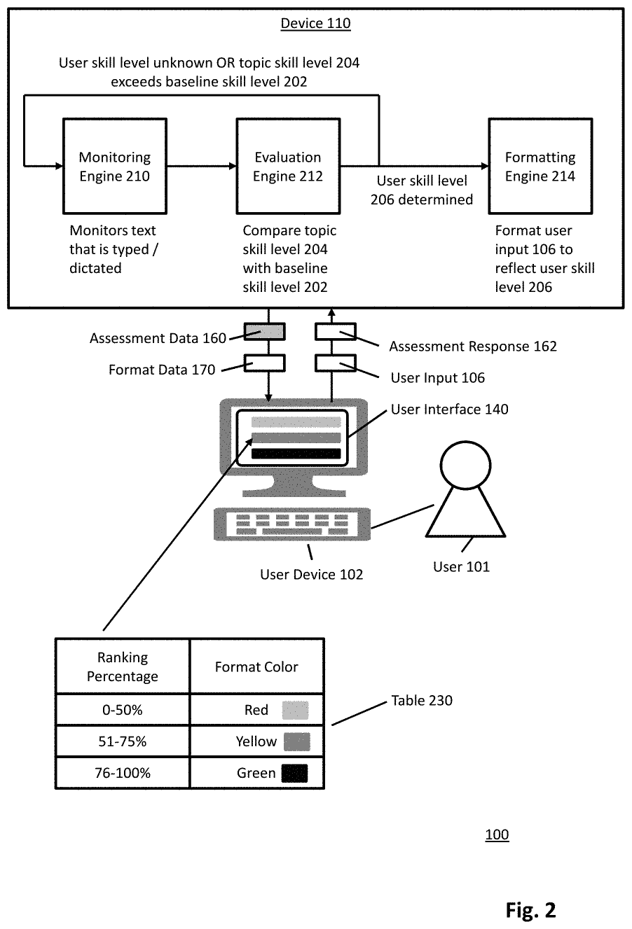

FIG. 2 illustrates an example implementation of cognitive experience assessment with visual indicator, arranged in accordance with at least some embodiments described herein. FIG. 2 may be described below with references to the above descriptions of FIG. 1.

In an example embodiment, the device 110 may include one or more components configured to perform respective tasks, such as a monitoring engine 210, an evaluation engine 212, and a formatting engine 214. The monitoring engine 210, the evaluation engine 212, and the formatting engine 214, may each be hardware module or software module, and may be controlled by the processor 120. The monitoring engine 210 may be configured to monitor texts that is being typed, dictated, or inputted by the user device 102. The evaluation engine 212 may be configured to apply natural language processing algorithms (which may be part of the instructions 124) on the data monitored by the monitoring engine 210. The evaluation engine 212 may be further configured to perform comparisons between a topic skill level 204 (described below) and a baseline skill level 202 (described below), and also a determination of a user skill level 206 (described below). Upon determining the user skill level 206, the formatting engine 214 may format the user input 106 to reflect the user skill level 206 determined by the evaluation engine 212.

In an example shown in FIG. 2, the user 101 may generate user input 106 by writing or typing a recipe to make a dish X, where a name of the dish X may be mapped to an expert level in the topic of culinary arts in the topic skill database 128. The user 101 may be mapped to a novice level of in culinary arts in the user skill database 126 at the time when the user input 106 is being generated. As the user 101 generates the user input 106, the monitoring engine 210 may monitor the text being generated as the user input 106 (e.g., by keystroke monitoring). The monitoring engine 210 may detect particular texts and phrases, such as cook, recipe, ingredients, dish X, and/or other texts. The monitoring engine 210 may forward the detected texts and phrases to the evaluation engine 212. The evaluation engine 212 may apply natural language processing algorithms on the detected texts to identify topics relating to the detected texts. The evaluation engine 212 may further identify entries in the topic skill database 128 that includes the detected texts to identify the topic of culinary arts, and may determine that dish X is mapped to an expert level in culinary arts. The evaluation engine 212 may establish a topic skill level 204 as expert level. Further, based on the indication of novice level of the user 101 in culinary arts, the evaluation engine 212 may establish a baseline skill level 202 as novice level.

The evaluation engine 212 may compare the topic skill level 204 (expert) with the baseline skill level 202 (novice). Upon the comparison, the evaluation engine 212 may determine that there is a mismatch between the topic skill level 204 and the baseline skill level 202. In response to the mismatch indicating that the topic skill level 204 is a higher level (more experienced) than the baseline skill level 202, the processor 120 may send the assessment data 160, such as a questionnaire, to the user device 102. The user 101 may use the user device 102 to input an assessment response 162, where the assessment response 162 may be a response to the assessment data 160, such as answers to a questionnaire. The evaluation engine 212 may evaluate the assessment response 162 to determine whether the user 101 has improved in culinary arts. For example, the evaluation engine 212 may determine a score of the assessment response 162 (e.g., number of correct answers to the questionnaire). The experience assessment instructions 124 may store thresholds (e.g., passing scores) that may classify the assessment response 162 into different skill levels. For example, a score of below 50% may be classified as a novice level, a score between 51-75% may be classified as an intermediate level, and a score above 75% may be classified as an expert level.

In some examples, in response to the mismatch indicating that the topic skill level 204 is a higher level (more experienced) than the baseline skill level 202, the processor 120 may generate the assessment data 160. For example, the processor 120 may select a set of questions that may be mapped to intermediate and/or expert levels in culinary arts, and may compile the selected questions into a questionnaire.

In an example, if the questionnaire includes questions of different levels of experience, the assessment response 162 may be evaluated based on responses to questions of each level. For example, if the assessment response 162 answered all intermediate level questions correctly, but answered only a small portion of expert level questions correctly, the processor 120 or the evaluation engine 212 may determine that the user skill level 206 is intermediate.

In the example in FIG. 2, if the user 101 has improved to an expert level in culinary arts, the evaluation engine 212 may establish the user skill level 206 as expert level. The evaluation engine 212 may forward the user skill level 206 to the formatting engine 214. The formatting engine 214 may format the user input 106 according to the user skill level 206 (expert). In another example, if user 101 has improved to an intermediate level, which is between the novice level and the expert level, the formatting engine 214 may format the user input 106 according to the user skill level of intermediate level. In another example, if the user 101 has not improved and remains at the novice level, the formatting engine 214 may format the user input 106 according to the user skill level of novice.

In another example, the dish X may be mapped to an expert level in culinary arts in the topic skill database 128, and the user 101 may be mapped to an expert level in culinary arts in the user skill database 126, such that the baseline skill level 202 is expert. The evaluation engine 212 may determine that there is a match between the baseline skill level 202 and the topic skill level 204, and may not send the assessment data 160 to the user device 102. In response to the match, the formatting engine 214 may format the user input 106 in accordance with the matched skill level (e.g., the expert level).

In another example, the user 101 may not use device 102 to generate the assessment response 162. In response to not receiving the assessment response 162, the evaluation engine 212 may establish the user skill level 206 as the baseline skill level 202, such that the formatting engine 214 may format the user input 106 in accordance with the baseline skill level 202. For example, if the baseline skill level 202 is novice and the topic skill level is expert, in response to not receiving the assessment response, the formatting engine 214 may format the user input 106 in accordance with the baseline skill level 202 of novice.

In another example, in response to not receiving the assessment response 162, the evaluation engine 212 may notify the formatting engine 214 to not format the user input 106. Thus, the device 110 may output the user input 106 on the user interface 140 without any formatting, and a user viewing the unformatted user input 106 may be aware that a skill level of the author is unknown.

In another example, at the time of generating the user input 106, the user skill database 126 may not indicate a skill level of the user 101 in the topic of the user input, e.g., culinary arts. In order to establish the baseline skill level 202, the processor 120 may send the assessment data 160 to the user device 102. The user device 102 may return the assessment response 162, and the processor 120 may establish the baseline skill level 202 based on the evaluation of the assessment response 162.

In another example, if the evaluation of the assessment response 162 indicates that the user 101 has not improved in a particular topic, or indicates that the user 101 may need to improve in the particular topic, the processor 120 may output one or more recommendations on the user interface 140. For example, the recommendation may be a link to a video showing how to make dish X. The recommendations may include links, videos, documents, information to schools or training facilities, and/or other recommendations or suggestions that may be considered by the user 101 to improve experience in the particular topic.

An example table 230 depicted in FIG. 2 shows an example embodiment of the system 100 where the user skill level 206 may be based on a ranking of the user skill level 206 of the user 101 with respect to other users of the system 100. For example, as indicated by the table 130, inputs authored by users who are ranked in the range 0-50% may be formatted with pixel values representing red, inputs authored by users who are ranked in the range 51-75% may be formatted with pixel values representing yellow, and inputs authored by users who are ranked in the range 76-100% may be formatted with pixel values representing green. The correspondences between rankings and formats, such as the table 230, may be stored in the memory 122. In some examples, the ranking of the user skill level 206 may be based on a score of the assessment response 162 received at the system 100. For example, the assessment response 162 may have a score that is higher than 80% of users, and thus, the user input 106 authored by the user 101 may be formatted with a user skill level that corresponds to 80% more experienced than other users.

As a result of implementing the system 100 to format the user input 106, the user input 106 may be displayed on the user interface 140 in one or more formats. A user who may be viewing the user input 106 on the user interface 140 may then determine a reliability of the information being displayed in the user interface 140. For example, if a user posted a question of how to make dish X on a forum, the user may view recipes posted from other users, where each recipe may be formatted with respective format to indicate a skill level of the authors who posted the recipes. The user who posted the question may be presented with a plurality of responses with visual indicators indicating a skill level of the user responding to the question. Therefore, the implementation of the system 100 may provide information that may assists the user who posted the question to identify reliable answers by other users.

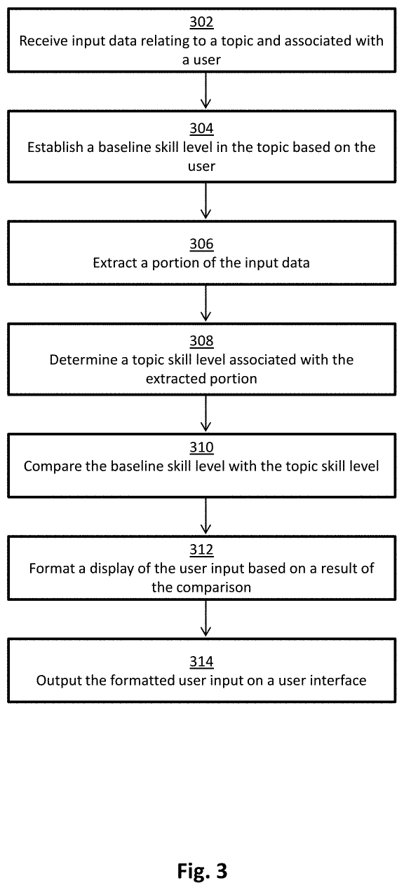

FIG. 3 illustrates a flow diagram relating to cognitive experience assessment with visual indicator, arranged in accordance with at least some embodiments presented herein. The process in FIG. 3 may be implemented using, for example, computer system 100 discussed above. An example process may include one or more operations, actions, or functions as illustrated by one or more of blocks 302, 304, 306, 308, 310, 312, and/or 314. Although illustrated as discrete blocks, various blocks may be divided into additional blocks, combined into fewer blocks, eliminated, or performed in parallel, depending on the desired implementation.

Processing may begin at block 302, where a processor may receive input data relating to a topic and associated with a user. The input data may include a plurality of texts.

Processing may continue from block 302 to block 304. At block 304, the processor may establish a baseline skill level in the topic based on the user.

Processing may continue from block 304 to block 306. At block 306, the processor may extract a portion of the input data. For example, the processor may extract texts associated with the topic from the user input.

Processing may continue from block 306 to block 308. At block 308, the processor may determine a topic skill level associated with the extracted portion.

Processing may continue from block 308 to block 310. At block 310, the processor may compare the baseline skill level with the topic skill level.

Processing may continue from block 310 to block 312. At block 312, the processor may format a display of the user input based on a result of the comparison.

Processing may continue from block 312 to block 314. At block 314, the processor may output the formatted user input on a user interface. The formatted user input may indicate a user skill level of the user in the topic. In an example, the user skill level may be the same as the baseline skill level when the result of the comparison indicates that the topic skill level is same as the baseline skill level. In another example, the user skill level may be the baseline skill level when the result of the comparison indicates that the baseline skill level is higher (more experienced) than the topic skill level. In another example, when the baseline skill level is lower (less experienced) than the topic skill level, the processor may determine the user skill level of the user in the topic by sending assessment data to a device that generated the user input. The assessment data may be related to the topic. The processor may receive an assessment response from the device, where the assessment response may be a reply to the assessment data. The processor may determine the user skill level based on the assessment response.

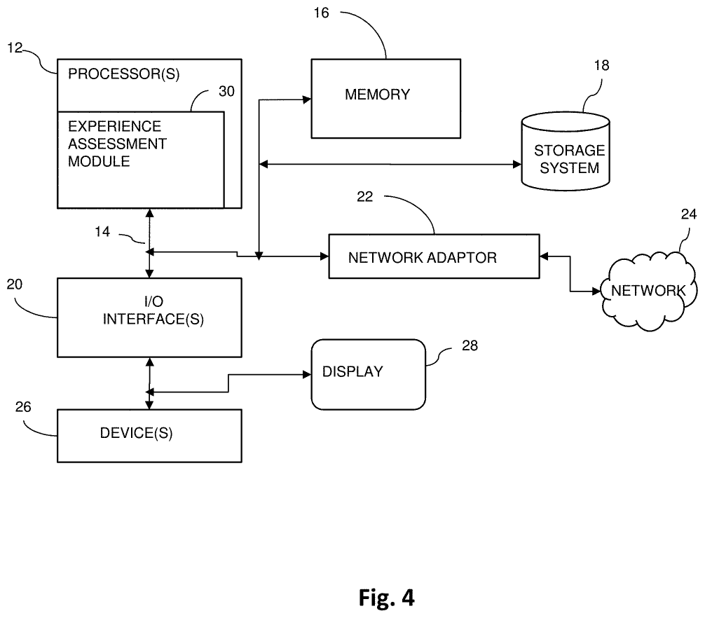

FIG. 4 illustrates a schematic of an example computer or processing system that may implement cognitive experience assessment with visual indicator in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, supercomputers, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 (e.g., experience assessment module 30) that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

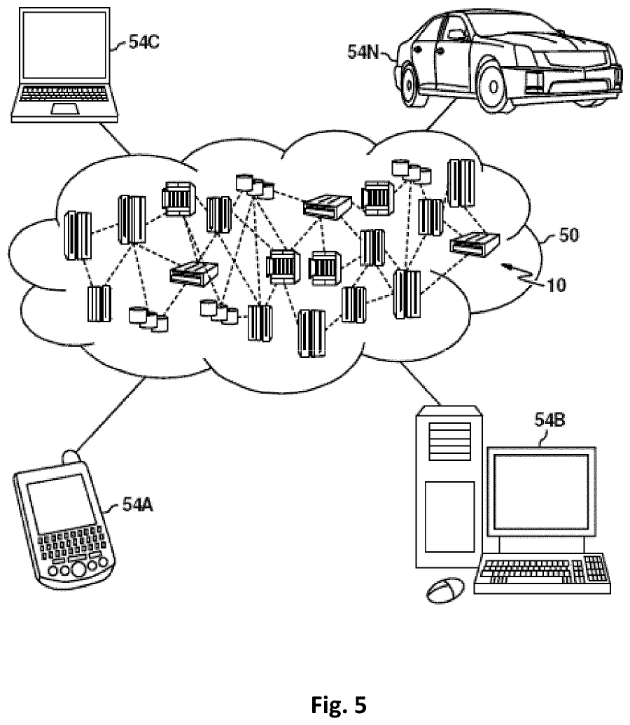

FIG. 5 depicts a cloud computing environment according to an embodiment of the present invention. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

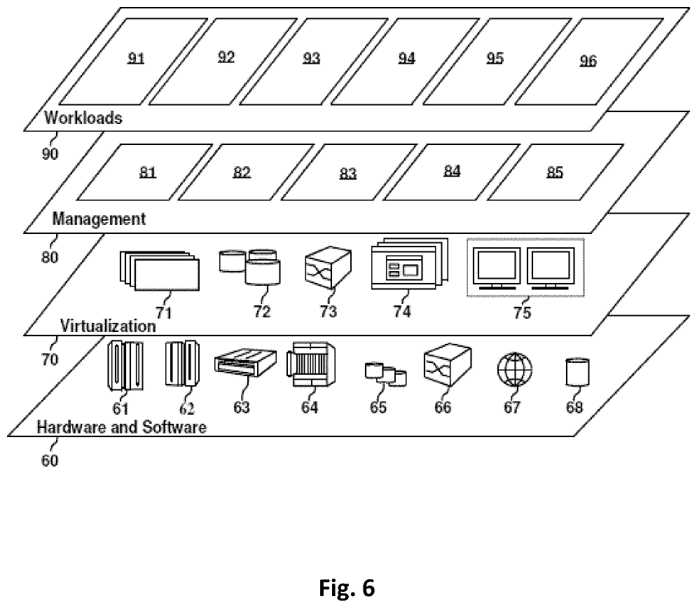

FIG. 6 depicts abstraction model layers according to an embodiment of the present invention. Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive experience assessment 96.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving, by a processor, input data relating to a topic, wherein the input data is associated with a user;
establishing, by the processor, a baseline skill level in the topic based on the user;
extracting, by the processor, a portion of the input data;
determining, by the processor, a topic skill level associated with the extracted portion;
comparing, by the processor, the baseline skill level with the topic skill level;
formatting, by the processor, a display of the user input based on a result of the comparison; and
outputting, by the processor, the formatted user input on a user interface, wherein the formatted user input indicates a user skill level of the user in the topic.

2. The method of claim 1, wherein the input data includes a plurality of texts, and extracting the portion of the input data includes extracting at least one text associated with the topic.

3. The method of claim 1, wherein the user skill level is the baseline skill level when the result of the comparison indicates that the topic skill level is same as the baseline skill level.

4. The method of claim 1, wherein the user skill level is the baseline skill level when the result of the comparison indicates that the baseline skill level is higher than the topic skill level.

5. The method of claim 1, wherein the result of the comparison indicates that the baseline skill level is lower than the topic skill level, and the method further comprising determining, by the processor, the user skill level of the user in the topic.

6. The method of claim 5, wherein determining the user skill level comprises:
sending, by the processor, assessment data to a device that generated the user input, wherein the assessment data relates to the topic;
receiving, by the processor, an assessment response from the device, wherein the assessment response is a reply to the assessment data; and
determining, by the processor, the user skill level based on the assessment response.

7. The method of claim 6, wherein in response to not receiving the assessment response from the device, the method further comprising formatting, by the processor, the display of the user input based on the baseline skill level that is lower than the topic skill level.

8. The method of claim 1, wherein identifying the baseline skill level of the user in the topic comprises:
sending, by the processor, assessment data to a device that generated the user input, wherein the assessment data relates to the topic;
receiving, by the processor, an assessment response from the device, wherein the assessment response is a reply to the assessment data; and
determining, by the processor, the baseline skill level based on the assessment response.

9. A system comprising:
a memory configured to store a set of instructions;
a processor configured to be in communication with the memory, the processor being configured to execute the set of instructions to:
receive input data relating to a topic, wherein the input data is associated with a user;
establish a baseline skill level in the topic based on the user;
extract a portion of the input data;
determine a topic skill level associated with the extracted portion;
compare the baseline skill level with the topic skill level;
format a display of the user input based on a result of the comparison; and
output the formatted user input on a user interface, wherein the formatted user input indicates a user skill level of the user in the topic.

10. The system of claim 9, wherein the user skill level is the baseline skill level when the result of the comparison indicates that the topic skill level is same as the baseline skill level.

11. The system of claim 9, wherein the user skill level is the baseline skill level when the result of the comparison indicates that the baseline skill level is higher than the topic skill level.

12. The system of claim 9, wherein the result of the comparison indicates that the baseline skill level is lower than the topic skill level, and the processor is further configured to determine the user skill level of the user in the topic.

13. The system of claim 12, wherein the processor is further configured to:
send assessment data to a device that generated the user input, wherein the assessment data relates to the topic;
receive an assessment response from the device, wherein the assessment response is a reply to the assessment data; and
determine the user skill level based on the assessment response.

14. The system of claim 13, wherein in response to not receiving the assessment response from the device, the processor is further configured to format the display of the user input based on the baseline skill level that is lower than the topic skill level.

15. A computer program product for formatting a display of user input, the computer program product comprising a computer readable storage medium having program instructions embodied therewith, the program instructions executable by a processing element of a device to cause the device to:
receive input data relating to a topic, wherein the input data is associated with a user;
establish a baseline skill level in the topic based on the user;
extract a portion of the input data;
determine a topic skill level associated with the extracted portion;
compare the baseline skill level with the topic skill level;
format a display of the user input based on a result of the comparison; and
output the formatted user input on a user interface, wherein the formatted user input indicates a user skill level of the user in the topic.

16. The computer program product of claim 15, wherein the user skill level is the baseline skill level when the result of the comparison indicates that the topic skill level is same as the baseline skill level.

17. The computer program product of claim 15, wherein the user skill level is the baseline skill level when the result of the comparison indicates that the baseline skill level is higher than the topic skill level.

18. The computer program product of claim 15, wherein the result of the comparison indicates that the baseline skill level is lower than the topic skill level, and the processor is further configured to determine the user skill level of the user in the topic.

19. The computer program product of claim 18, wherein the program instructions are further executable by the processing element of the device to cause the device to:
send assessment data to a device that generated the user input, wherein the assessment data relates to the topic;
receive an assessment response from the device, wherein the assessment response is a reply to the assessment data; and
determine the user skill level based on the assessment response.

20. The computer program product of claim 19, wherein the program instructions are further executable by the processing element of the device to cause the device to format the display of the user input based on the baseline skill level that is lower than the topic skill level.
